(19) United States
(12) Patent Application Publication
(10) Pub. No.: US 2017/0131946 A1
(43) Pub. Date: May 11, 2017

(54) METHOD AND DEVICE FOR FORMATTING STORAGE OF MOBILE TERMINAL

(71) Applicants: LE HOLDINGS (BEIJING) CO., LTD., Beijing (CN); Lemobile Information Technology (Beijing) Co., Ltd, Beijing (CN)

(72) Inventor: Yan YU, Beijing (CN)

(21) Appl. No.: 15/247,822

(22) Filed: Aug. 25, 2016

Related U.S. Application Data
(63) Continuation of application No. PCT/CN2016/088541, filed on Jul. 5, 2016.

(30) Foreign Application Priority Data
Nov. 6, 2015 (CN) 201510756772.2

(51) Int. Cl. G06F 3/06

(52) U.S. Cl. CPC G06F 3/0652; G06F 3/0626; G06F 3/0679; H04W 88/02

(57) ABSTRACT

An embodiment of the present disclosure discloses a method and a device for formatting the storage of a mobile terminal, wherein the method comprises the following steps: determining whether the storage of the mobile terminal is formatted when it is detected that the mobile terminal is started; and executing formatting operations on the storage of the mobile terminal if it is determined that the storage of the mobile terminal is not formatted, wherein the formatting operations comprise the following steps of acquiring an available storage capacity value of the storage of the mobile terminal and replacing a storage capacity value which is preset in software codes with the available storage capacity value, wherein the software codes are software codes which are shared by storages of different storage capacities.

### CROSS-REFERENCE TO RELATED APPLICATIONS

This application is a continuation of International Application No. PCT/CN2016/088541, filed on Jul. 5, 2016, which is based upon and claims priority to Chinese Patent Application No. CN201510756772.2, filed on Nov. 6, 2015, the entire contents of which are incorporated herein by reference.

### TECHNICAL FIELD

The disclosure relates to the technical field of storages, in particular to a method for formatting the storage of a mobile terminal and a device for formatting the storage of the mobile terminal.

### BACKGROUND

With the development of information technology, mobile terminals become more and more popular. In order to meet requirements of different user groups, mobile terminal manufacturers manufacture the mobile terminals of different storage capacities, such as 32G, 64G or 128G etc.

In the prior art, it is required to maintain a set of software codes corresponding to a storage of a certain storage capacity, and accordingly it is required to maintain a plurality of sets of codes for different storage capacities, which results in high cost for code maintenance and high complexity for code management.

### SUMMARY

An embodiment of the present disclosure discloses a method and a device for formatting the storage of a mobile terminal to solve the problems in the prior art of high cost for code maintenance and high complexity for code management as it is required to maintain a plurality of sets of codes for storages of different storage capacities.

According to one aspect of the present disclosure, an embodiment of the present disclosure provides a method for formatting the storage of the mobile terminal, the method including the following steps:

determining whether the storage of the mobile terminal is formatted when it is detected that the mobile terminal is started;

executing formatting operations on the storage of the mobile terminal if it is determined that the storage of the mobile terminal is not formatted, wherein the formatting operations include the following steps of acquiring an available storage capacity value of the storage of the mobile terminal and replacing a storage capacity value which is preset in software codes with the available storage capacity value, wherein the software codes are software codes which are shared by storages of different storage capacities.

According to another aspect of the present disclosure, an embodiment of the present disclosure further provides a device for formatting a storage of a mobile terminal, the device including:

a formatting determining module, which is configured to determine whether the storage of the mobile terminal is formatted when it is detected that the mobile terminal is started; and

a formatting module, which is configured to execute formatting operations on the storage of the mobile terminal if it is determined that the storage of the mobile terminal is not formatted, wherein the formatting operations include the following steps of acquiring an available storage capacity value of the storage of the mobile terminal and replacing a storage capacity value which is preset in software codes with the available storage capacity value, wherein the software codes are software codes which are shared by storages of different storage capacities.

According to a further aspect of the present disclosure, a computer program is provided, including a computer readable code, wherein the computer readable code causes a mobile terminal to execute a formatting operation on a storage of the mobile terminal when operating on the mobile terminal.

According to another further aspect of the present disclosure, a computer readable medium is provided, wherein the computer readable program is stored in the computer readable medium.

The present disclosure has the following beneficial effects:

according to the embodiments of the present disclosure, it is required to firstly determine whether the storage of the mobile terminal is formatted when the mobile terminal is started; if the storage is not formatted, it is required to execute on the storage formatting operations of acquiring the available storage capacity value of the storage of the mobile terminal and replacing the storage capacity value which is preset in the software code with the available storage capacity value. According to the embodiments of the present disclosure, as a set of shared software codes are employed in the storages of different storage capacities, the compatibility of the software codes is enhanced, the dependence of the software codes on the storage is reduced, and the maintenance cost for the software codes is lowered.

The foregoing illustration is only an overview of a technical solution of the present disclosure. In order to clearly illustrate the technical means of the present disclosure to ensure the present disclosure is implementable according to content of the specifications, and in order to make the above and other purposes, characteristics and advantages of the present disclosure more apparent to understand, embodiments of the present disclosure are specifically illustrated as follows.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a steps flow chart of a method for formatting a storage of a mobile terminal according to a first embodiment of the present disclosure.

FIG. 2 is a steps flow chart of a method for formatting a storage of a mobile terminal according to a second embodiment of the present disclosure.

FIG. 3 is a structure block diagram of a device for formatting a storage of a mobile terminal according to the first embodiment of the present disclosure.

FIG. 4 schematically illustrates a block diagram of a mobile terminal used to execute the method according to the present disclosure.

FIG. 5 schematically illustrates a storage unit used to keep or carry a program code for realizing the method according to the present disclosure.

### DETAILED DESCRIPTION

In order to make objects, technical solutions and advantages of the embodiments of the present disclosure apparent, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, those of ordinary skill in the art can obtain other embodiment(s), without any inventive work, which should be within the scope of the present disclosure.

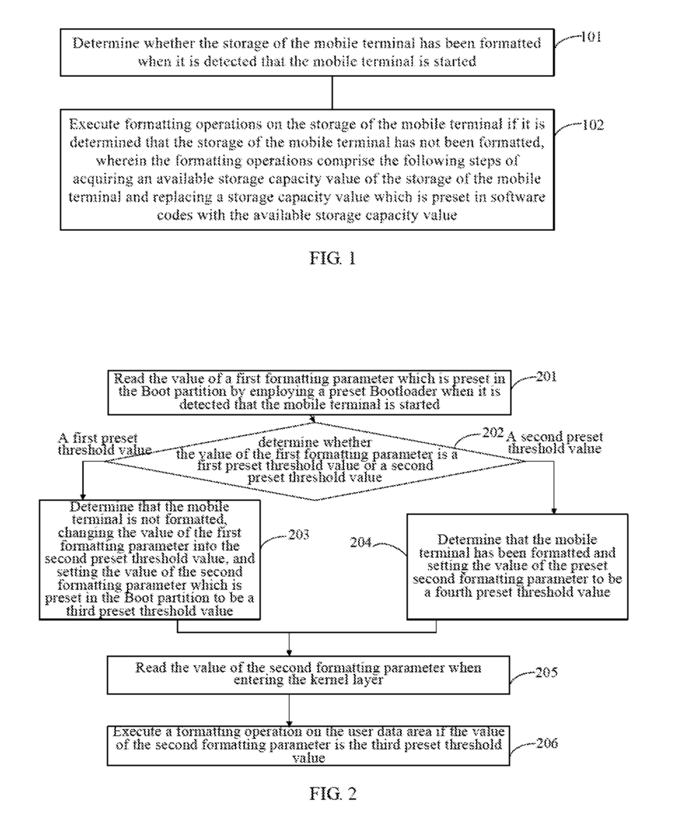

With reference to FIG. 1, which illustrates a steps flow chart of a method for formatting a storage of a mobile terminal according to a first embodiment of the present disclosure, the method may specifically include the following steps:

step 101 of determining whether the storage of the mobile terminal is formatted when it is detected that the mobile terminal is started:

step 102 of executing formatting operations on the storage of the mobile terminal if it is determined that the storage of the mobile terminal is not formatted, wherein the formatting operations include the following steps of acquiring an available storage capacity value of the storage of the mobile terminal and replacing a storage capacity value which is preset in software codes with the available storage capacity value, wherein the software codes are software codes which are shared by storages of different storage capacities.

According to the embodiment of the present disclosure, it is required to firstly determine whether the storage of the mobile terminal is formatted when the mobile terminal is started; if the storage is not formatted, it is required to execute on the storage formatting operations of acquiring the available storage capacity value of the storage of the mobile terminal and replacing the storage capacity value which is preset in the software code with the available storage capacity value. According to the embodiment of the present disclosure, as a set of shared software codes are employed in the storages of different storage capacities, the compatibility of the software codes is enhanced, the dependence of the software codes on the storage is reduced, and the maintenance cost for the software codes is lowered.

With reference to FIG. 2, which illustrates a steps flow chart of a method for formatting a storage of a mobile terminal according to a second embodiment of the present disclosure.

According to the embodiment of the present disclosure, the method can be applied to the mobile terminal which includes the storage, wherein the storage may be preferably an eMMC (Embedded MultiMediaCard, a standard specification for embedded storage established by MultiMediaCard Association) storage which has an obvious advantage that a controller is integrated in a package. The eMMC storage provides a standard interface and manages a flash memory, so that mobile terminal manufacturers can focus on other parts of product development and shorten the time to roll out products in the market.

In general, an eMMC from a manufacturer may at least include the following parts:

a Boot partition, namely a start partition, which may include a first Boot partition Boot 1 and a second Boot partition Boot 2. The two partitions are well configured by the manufacturer during the production process, and can be used to store boot images, default configuration parameters and the like.

an RPMB (Replay Protected Memory Block), which is configured to store some special data which requires authorized access.

a User Data Area, namely a user partition or an area for user's read-write storage, wherein the storage capacity of the user data area is generally around 93% of the storage capacity of the entire eMMC; namely, the storage capacity of the user data area in a 4 GB eMMC is only 4 GB*93%=3809 MB.

The embodiment of the present disclosure provides a compatible solution with respect to different storage capacities of the eMMC, which may include the steps as follows.

Step 201: employing a bootstrap loader (Bootloader) to read the value of a first formatting parameter which is preset in the Boot partition when it is detected that the mobile terminal is started.

According to the embodiment of the present disclosure, the first formatting parameter (for an example, the first formatting parameter may be defined as an erase_data parameter) may be preset in the Boot partition of the eMMC, and may be a global variable used as an identifier for formatting an internal storage when the mobile terminal is powered on for the first time.

In practice, the first formatting parameter may be a boolean type parameter, and may be equal to true (or yes, namely a first preset threshold value) and false (or no, namely a second preset threshold value). In the embodiment of the present disclosure, a default value of the first formatting parameter may be the first preset threshold value.

The mobile terminal may firstly read the value of the first formatting parameter from the Boot partition when being powered on. During the specific implementation, the mobile terminal may employ the Bootloader to read the value of the first formatting parameter from the Boot partition, wherein the bootstrap loader (Bootloader) is a first piece of codes which are executed by an embedded system after the powering on, after a CPU (Central Processing Unit) and related hardware are formatted, and an embedded application which is mapped or solidified by an operating system is loaded in the internal storage, jump to a space where the operating system is located and start the operation of the operating system.

Step 202: determining whether the value of the first formatting parameter is the first preset threshold value or the second preset threshold value; execute step 203 if the value of the first formatting parameter is the first preset threshold value; or execute step 204 if the value of the first formatting parameter is the second preset threshold value.

For example, the Bootloader reads the value of erase_data from the Boot partition; execute step 203 if erase_data=yes; or execute step 204 if erase_data=no.

Step 203: determining that the mobile terminal is not formatted, changing the value of the first formatting parameter into the second preset threshold value, and setting the value of the second formatting parameter which is preset in the Boot partition to be a third preset threshold value.

Specifically, if the value of the first formatting parameter is the first preset threshold value, for example when erase_data-yes, it can be determined that the mobile terminal is not formatted, and the value of the first formatting parameter can be changed into the second preset threshold value at this moment; for example to set erase_data=no, it can be read that the value of the first formatting value is the second preset threshold value when the mobile terminal is powered on for the next time.

According to the embodiment of the present disclosure, the second formatting parameter (as an example, the second formatting parameter can be defined as a cmdline.android.x.erase_userdata parameter) is further defined in the Boot partition as an identifier for formatting the internal storage after the operating system of the mobile terminal enters a kernel layer. When it is determined that the mobile terminal is not formatted, the second formatting parameter can be further read, and the value of the second formatting parameter can be configured as the third preset threshold value, for example, to set cmdline.android.x.erase_userdata=yes.

Step 204: determining that the mobile terminal is formatted and setting the value of the preset second formatting parameter to be a fourth preset threshold value.

If the value of the first formatting parameter is the second preset threshold, for example when erase_data=no, it can be determined that the mobile terminal is formatted, and the value of the second formatting parameter can be configured.

Step 205 of reading the value of the second formatting parameter when entering the kernel layer of the operating system.

It is allowed to enter the kernel layer of the operating system of the mobile terminal when the Bootloader finishes operating; in the kernel layer of the operating system, it can be determined whether the storage of the mobile terminal is formatted by reading the value of the second formatting parameter.

Step 206 of executing a formatting operation on the user data area if the value of the second formatting parameter is the third preset threshold value.

When the kernel layer is entered, if it is read that the value of the second formatting parameter is the third preset threshold value, for example cmdline.android.x.erase_userdata=yes, it can be determined that in the kernel layer the formatting operation is not executed on the mobile terminal, and the formatting operation can be executed on the mobile terminal in the kernel layer at the moment, and specifically the formatting operation can be executed on the user data area of the eMMC, wherein the formatting operation refers to an operation to initialize a magnetic disk (which may be the eMMC according to the embodiment of the present disclosure) or a partition in the magnetic disk, and such operation will generally lead to the clearance of all documents in the existing magnetic disk or partition.

According to one embodiment, the formatting operation may specifically include the steps of acquiring an available storage capacity value of the storage of the mobile terminal and replacing a storage capacity value, which is preset in software codes with the available storage capacity value.

Specifically according to the embodiment of the present disclosure, a set of shared software codes may be set for various storages of different storage capacities to realize the compatibility of the software codes; and in order to realize the sharing performance, a preset storage capacity value, such as 10G may be set in the shared software codes. When the shared software codes are in operation and the preset storage capacity value is read, the available storage capacity value of the storage of the mobile terminal may be further acquired, and the storage capacity value which is preset in the shared software codes may be replaced with the available storage capacity value so as to display the available storage capacity value of the storage in the mobile terminal.

According to a preferable embodiment of the present disclosure, the step of acquiring the available storage capacity value of the storage of the mobile terminal may be realized by the following means.

Acquiring an actual storage capacity value of the storage of the mobile terminal; computing an occupied storage capacity value of the storage of the mobile terminal; and computing a difference value of the actual storage capacity value and the occupied storage capacity value to result in the available storage capacity value of the storage.

For example, the actual storage capacity of a first storage is 32G and the occupied storage capacity, which is occupied by applications installed in the mobile terminal, is 4G the available storage capacity value of the first storage is 28G. If the preset storage capacity value in the shared software codes is 10G, the 10G in the software codes can be replaced with 28G so that the displayed available storage capacity value of mobile terminal is 28G and therefore the formatting of internal storage of the mobile terminal is completed.

For another example, the actual storage capacity of a second storage is 16G and the occupied storage capacity, which is occupied by applications installed in the mobile terminal, is 2G, the available storage capacity value of the second storage is 14G. If the preset storage capacity value in the shared software codes is 10G the 10G in the software codes can be replaced with 14G; so that the displayed available storage capacity value of mobile terminal is 14G and therefore the formatting of internal storage of the mobile terminal is completed.

In another aspect, if the value of the second formatting parameter is the fourth preset threshold value, for example cmdline.android.x.erase_userdata=no, it can be determined that in the kernel layer the formatting operation is executed on the mobile terminal, and the flow can be ended at this moment.

According to the embodiment of the present disclosure, the eMMC of different storage capacities can share a set of universal software codes, and the storage capacity value which is preset in the shared software codes is replaced with the acquired available storage capacity value of the eMMC to realize the compatibility of the software codes, and therefore the trouble of maintaining a plurality of sets of codes is avoided; moreover, it is not required for the software codes to consider more hardware variations, so that the dependence of the software codes on the hardware is reduced, and the compiling complexity that it is required to use a compiler switch to control the codes is avoided.

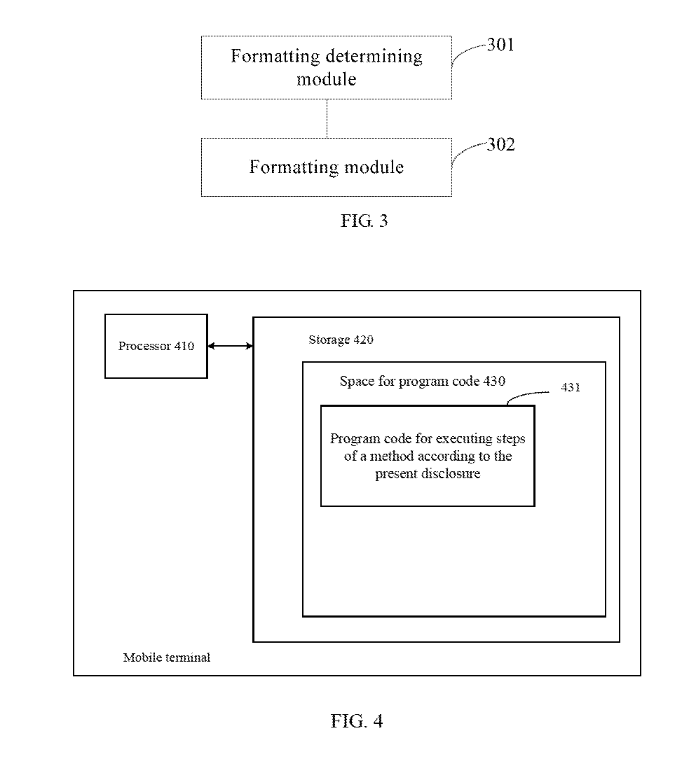

With reference to FIG. 3, which illustrates a structure block diagram of a device for formatting a storage of a mobile terminal according to an embodiment of the present disclosure, the device may specifically include the following modules:

a formatting determining module 301, which is configured to determine whether the storage of the mobile terminal is formatted when it is detected that the mobile terminal is started, and

a formatting module 302, which is configured to execute formatting operations on the storage of the mobile terminal if it is determined that the storage of the mobile terminal is not formatted, wherein the formatting operations include the following steps of acquiring an available storage capacity value of the storage of the mobile terminal and replacing the storage capacity value which is preset in software codes with the available storage capacity value.

According to a preferable embodiment of the present disclosure, the storage includes a Boot partition, and the formatting determining module 301 may include the following sub-modules:

a first formatting parameter reading sub-module, which is configured to read the value of a first formatting parameter which is preset in the Boot partition by employing a preset bootstrap loader (Bootloader);

a determining sub-module, which is configured to determine whether the value of the first formatting parameter is a first preset threshold value or a second preset threshold value;

a first determining sub-module, which is configured to determine that the storage of the mobile terminal is not formatted when the value of the first formatting parameter is the first preset threshold value; and

a second determining sub-module, which is configured to determine that the storage of the mobile terminal is formatted when the value of the first formatting parameter is the second preset threshold value.

According to a preferable embodiment of the present disclosure, the device may further include the following modules:

a first parameter setting module, which is configured to change the value of the first formatting parameter into the second preset threshold and setting the value of the second formatting parameter which is preset in the Boot partition to a third preset threshold value when it is determined that the storage of the mobile terminal is not formatted; and

a second parameter setting module, which is configured to set the value of the second formatting parameter to a fourth preset threshold value when it is determined that the storage of the mobile terminal is formatted.

According to a preferable embodiment of the present disclosure, the storage further includes a user data area, and the formatting module 302 may include the following sub-modules:

a second formatting parameter reading sub-module, which is configured to read the value of the second formatting parameter when entering a kernel layer of an operating system; and

a partition formatting sub-module, which is configured to execute a formatting operation on the user data area when the value of the second formatting parameter is the third preset threshold value.

According to a preferable embodiment of the present disclosure, the step of acquiring an available storage capacity value of the storage of the mobile terminal is realized by the following means:

acquiring an actual storage capacity value of the storage of the mobile terminal;

computing an occupied storage capacity value of the storage of the mobile terminal; and

computing a difference value of the actual storage capacity value and the occupied storage capacity value to result in the available storage capacity value of the storage.

The device embodiment in combination with FIG. 3 is briefly described herein as they are substantially similar to method embodiments; please refer to the description of the method embodiments for associated parts.

Client or server embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

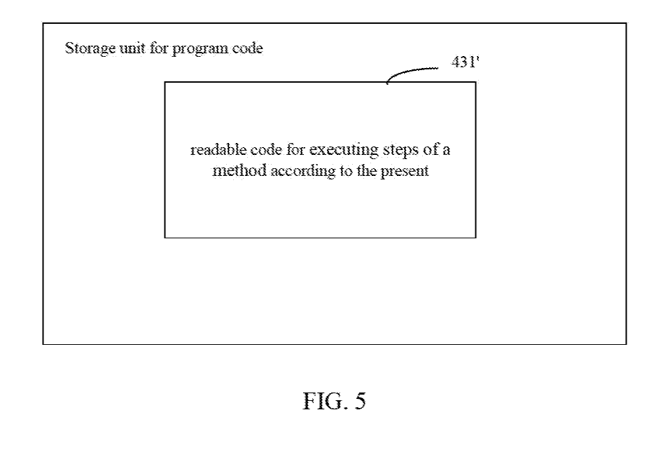

For example, FIG. 4 illustrates a block diagram of a mobile terminal for executing the method according the disclosure. Traditionally, the mobile terminal includes a processor 410 and a computer program product or a computer readable medium in form of a memory 420. The memory 420 could be electronic memories such as flash memory, EEPROM (Electrically Erasable Programmable Read-Only Memory). EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed for example in an appropriate form. Usually, the memory cell includes computer readable codes 431′ which can be read for example by processors 410. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A method for formatting storage of a mobile terminal, comprising:
determining whether the storage of the mobile terminal is formatted when it is detected that the mobile terminal is started; and
executing formatting operations on the storage of the mobile terminal if it is determined that the storage of the mobile terminal is not formatted, wherein the formatting operations comprise the following steps of acquiring an available storage capacity value of the storage of the mobile terminal and replacing a storage capacity value which is preset in software codes with the available storage capacity value, wherein the software codes are software codes which are shared by storages of different storage capacities.

2. The method according to claim 1, wherein the storage comprises a Boot partition, the step of determining whether the storage of the mobile terminal is formatted when it is detected that the mobile terminal is started comprising:
reading the value of a first formatting parameter which is preset in the Boot partition by employing a preset Bootloader when it is detected that the mobile terminal is started;
determining whether the value of the first formatting parameter is a first preset threshold value or a second preset threshold value;
determining that the storage of the mobile terminal is not formatted when the value of the first formatting parameter is the first preset threshold value; and
determining that the storage of the mobile terminal is formatted when the value of the first formatting parameter is the second preset threshold value.

3. The method according to claim 2, wherein before the step of executing formatting operations on the storage of the mobile terminal if it is determined that the storage of the mobile terminal is not formatted, the method further comprises:
changing the value of the first formatting parameter into the second preset threshold and setting the value of the second formatting parameter which is preset in the Boot partition to a third preset threshold value when it is determined that the storage of the mobile terminal is not formatted; and
setting the value of the second formatting parameter to a fourth preset threshold value when it is determined that the storage of the mobile terminal is formatted.

4. The method according to claim 3, wherein the storage further comprises a user data area, the step of executing the formatting operations on the storage of the mobile terminal if it is determined that the storage of the mobile terminal is not formatted comprising:
reading the value of the second formatting parameter when entering a kernel layer of an operating system; and
executing the formatting operations on the user data area if the value of the second formatting parameter is the third preset threshold value.

5. The method according to claim 1, wherein: acquiring the available storage capacity value of the storage of the mobile terminal is realized by the following means:
acquiring an actual storage capacity value of the storage of the mobile terminal:
computing an occupied storage capacity value of the storage of the mobile terminal; and
computing a difference value of the actual storage capacity value and the occupied storage capacity value to result in the available storage capacity value of the storage.

6. A mobile terminal for formatting storage, comprising:
at least one processor, and
a memory communicably connected with the at least one processor for storing instructions executable by the at least one processor, wherein execution of the instructions by the at least one processor causes the at least one processor to:
determine whether the storage of the mobile terminal is formatted when it is detected that the mobile terminal is started; and
execute formatting operations on the storage of the mobile terminal if it is determined that the storage of the mobile terminal is not formatted, wherein the formatting operations include acquiring an available storage capacity value of the storage of the mobile terminal and replacing a storage capacity value which is preset in software codes with the available storage capacity value, wherein the software codes are software codes which are shared by storages of different storage capacities.

7. The mobile terminal according to claim 6, wherein the storage comprises a Boot partition, the determine whether the storage of the mobile terminal is formatted when it is detected that the mobile terminal is started comprises:
reading the value of a first formatting parameter which is preset in the Boot partition by employing a preset Bootloader when it is detected that the mobile terminal is started;
determining whether the value of the first formatting parameter is a first preset threshold value or a second preset threshold value;
determining that the storage of the mobile terminal is not formatted when the value of the first formatting parameter is the first preset threshold value; and
determining that the storage of the mobile terminal is formatted when the value of the first formatting parameter is the second preset threshold value.

8. The mobile terminal according to claim 7, wherein execution of the instructions by the at least one processor further causes the at least one processor to:
change the value of the first formatting parameter into the second preset threshold and setting the value of the second formatting parameter which is preset in the Boot partition to a third preset threshold value when it is determined that the storage of the mobile terminal is not formatted; and
set the value of the second formatting parameter to a fourth preset threshold value when it is determined that the storage of the mobile terminal is formatted.

9. The mobile terminal according to claim 8, wherein the storage further comprises a user data area, wherein the execute formatting operations on the storage of the mobile terminal if it is determined that the storage of the mobile terminal is not formatted comprises:
reading the value of the second formatting parameter when entering a kernel layer of an operating system; and
executing a formatting operation on the user data area when the value of the second formatting parameter is the third preset threshold value.

10. The mobile terminal according to claim 6, wherein the available storage capacity value of the storage of the mobile terminal is acquired by the following means:
acquiring an actual storage capacity value of the storage of the mobile terminal:
computing an occupied storage capacity value of the storage of the mobile terminal; and
computing a difference value of the actual storage capacity value and the occupied storage capacity value to result in the available storage capacity value of the storage.

11. A non-transitory computer readable medium, storing executable instructions that, when executed by a mobile terminal, cause the mobile terminal to:
determine whether the storage of the mobile terminal is formatted when it is detected that the mobile terminal is started; and
execute formatting operations on the storage of the mobile terminal if it is determined that the storage of the mobile terminal is not formatted, wherein the formatting operations comprise the following steps of acquiring an available storage capacity value of the storage of the mobile terminal and replacing a storage capacity value which is preset in software codes with the available storage capacity value, wherein the software codes are software codes which are shared by storages of different storage capacities.

12. The non-transitory computer readable medium according to claim 11, wherein the storage comprises a Boot partition, the determine whether the storage of the mobile terminal is formatted when it is detected that the mobile terminal is started comprises:
reading the value of a first formatting parameter which is preset in the Boot partition by employing a preset Bootloader when it is detected that the mobile terminal is started;
determining whether the value of the first formatting parameter is a first preset threshold value or a second preset threshold value;
determining that the storage of the mobile terminal is not formatted when the value of the first formatting parameter is the first preset threshold value; and
determining that the storage of the mobile terminal is formatted when the value of the first formatting parameter is the second preset threshold value.

13. The non-transitory computer readable medium according to claim 12, wherein the mobile terminal is further caused to:
change the value of the first formatting parameter into the second preset threshold and setting the value of the second formatting parameter which is preset in the Boot partition to a third preset threshold value when it is determined that the storage of the mobile terminal is not formatted; and
set the value of the second formatting parameter to a fourth preset threshold value when it is determined that the storage of the mobile terminal is formatted.

14. The non-transitory computer readable medium according to claim 13, wherein the storage further comprises a user data area, wherein the execute formatting operations on the storage of the mobile terminal if it is determined that the storage of the mobile terminal is not formatted comprises:
reading the value of the second formatting parameter when entering a kernel layer of an operating system; and
executing a formatting operation on the user data area when the value of the second formatting parameter is the third preset threshold value.

15. The non-transitory computer readable medium according to claim 11, wherein the available storage capacity value of the storage of the mobile terminal is acquired by the following means:
acquiring an actual storage capacity value of the storage of the mobile terminal;
computing an occupied storage capacity value of the storage of the mobile terminal; and
computing a difference value of the actual storage capacity value and the occupied storage capacity value to result in the available storage capacity value of the storage.
